(19) United States
(12) Patent Application Publication
(10) Pub. No.: US 2016/0153528 A1
(43) Pub. Date: Jun. 2, 2016

(54) POWERTRAIN FOR HYBRID VEHICLE

(71) Applicant: Hyundai Motor Company, Seoul (KR)

(72) Inventor: Won Il Lee, Hwaseong-si (KR)

(73) Assignee: Hyundai Motor Company, Seoul (KR)

(21) Appl. No.: 14/720,350

(22) Filed: May 22, 2015

(30) Foreign Application Priority Data
Dec. 2, 2014 (KR) 10-2014-0170657

(51) Int. Cl. F16H 3/72; B60K 6/365; B60K 6/48; F16H 3/48

(52) U.S. Cl. CPC F16H 3/724; F16H 3/48; B60K 6/365; B60K 6/48; F16H 2200/2005; F16H 2200/2033; Y10S 903/91; B60Y 2200/92

(57) ABSTRACT

A power train for a hybrid vehicle may include a planetary gear set including a first rotary member connected to an output shaft and operated as an output element, a second rotary member supplied with power from an engine and operated as an input element, and a third rotary member connected to a first motor generator and operated as a fixing element selectively fixed by a friction member, and a second motor generator supplying power to the output shaft.

### CROSS REFERENCE TO RELATED APPLICATION

The present application claims priority of Korean Patent Application Number 10-2014-0170657 filed on Dec. 2, 2014, the entire contents of which application are incorporated herein for all purposes by this reference.

### BACKGROUND OF THE INVENTION

1. Field of the Invention

The present invention generally relates to a powertrain for a hybrid vehicle that can minimize a loss of electric power and a loss of engine power.

2. Description of Related Art

A hybrid vehicle, which is driven by electric power and power from an internal combustion engine, is controlled to drive in periods with high system efficiency by an engine and an electric motor, so the entire efficiency is high and an exhaust gas can be significantly reduced, thus such a vehicle has been increasingly used and is representative of a typical environment-friendly vehicle.

The way of splitting power in a hybrid vehicle is composed of a mechanical mechanism that transmits power from an engine directly to an output shaft, using a power split device that splits a power flow such as a planetary gear set and an electric mechanism that operates a generator to generate electricity using power from the engine and charges a battery with the generated power or drives a motor with the energy of the charged battery.

The power split type of hybrid system has an advantage in that it is possible to operate the engine independently from the output and freely turn on/off the engine during driving, and to achieve an electric vehicle mode.

Further, the effect of an electrically variable transmission (EVT) obtained by two motor generators allows for efficient operation of the engine and the motor has constant output at each speed, so there is essentially no need for a transmission.

However, according to a power-split type hybrid system, in an EV mode, not only the power split device, but gear sets and other motor generators are operated by power from one motor generator, so a loss of electric power from the driving motor is large and shifting efficiency (fuel efficiency) decreases.

Further, in an HEV mode using power from both an engine and a generator, not only the power split device, but more gear sets are operated by the power from the engine, so a loss of engine power increases and shifting efficiency (fuel efficiency) decreases accordingly, which is similar to the EV mode mentioned above.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a powertrain for a hybrid vehicle that can improve fuel efficiency by reducing the factors that cause a loss of power from an electric motor and an engine.

In an aspect of the present invention, there is provided a power train for a hybrid vehicle that may include a planetary gear set including a first rotary member connected to an output shaft and operated as an output element, a second rotary member supplied with power from an engine and operated as an input element, and a third rotary member connected to a first motor generator and operated as a fixing element selectively fixed by a friction member;, and a second motor generator supplying power to the output shaft.

In the planetary gear set, the first rotary member may be a sun gear, the second rotary member may be a carrier, and the third rotary member may be a ring gear.

The planetary gear set may be concentrically arranged on the output shaft.

The friction member may be a brake inside a transmission case.

The input shaft may be directly connected to the engine, a pair of external gears may be fitted on the input shaft and the output shaft, respectively, in mesh with each other, and the second motor generator may be connected to a motor input gear that is one of the pair of external gears on the input shaft.

The motor input gear may be relatively rotated on the input shaft.

An engine input gear may be fitted on the input shaft and may be engaged with the second rotary member.

According to the present invention, it is possible to reduce a loss of electric power and power from an engine by minimizing the number of components operated by power from a motor and the number of components operated by the power from the engine. Therefore, it is possible to improve shifting efficiency and reduce fuel consumption accordingly.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically showing the structure of a powertrain for a hybrid vehicle according to an exemplary embodiment of the present invention.

FIG. 2 is a diagram illustrating a power flow in an EV mode according to an exemplary embodiment of the present invention.

FIG. 3 is a view illustrating a power flow in a power split mode according to an exemplary embodiment of the present invention.

FIG. 4 is a diagram illustrating a power flow in power split OD mode according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Preferred embodiments of the present invention will be described hereafter in detail with reference to the accompanying drawings.

A powertrain for a hybrid vehicle of the present invention includes an engine 1, a planetary gear set PG, a first motor generator MG1, and a second motor generator MG2.

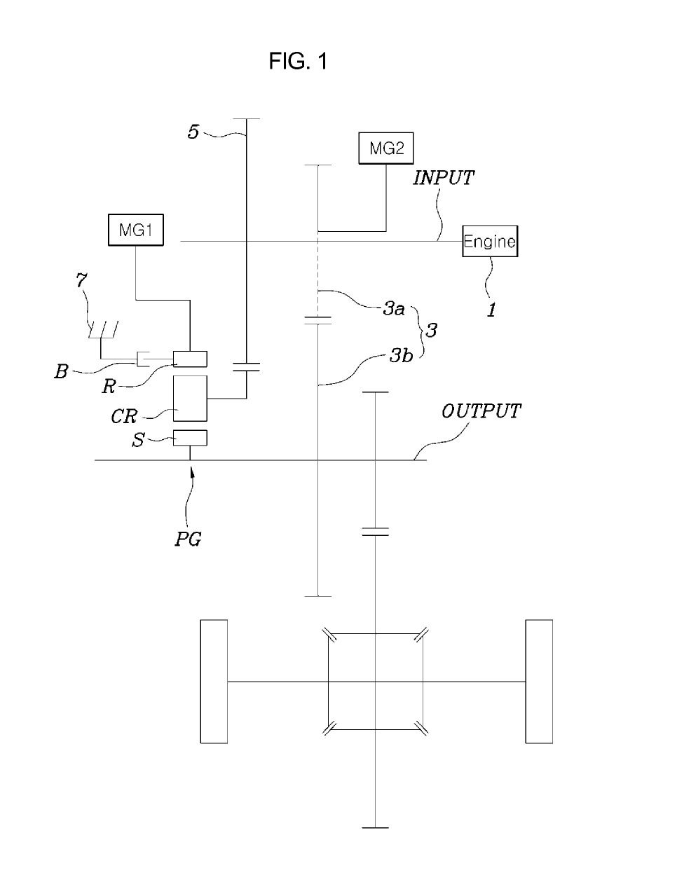

Describing the present invention in detail with reference to FIG. 1, first, the planetary gear set PG includes three rotary members that rotate together with each other, in which the rotary members are a first rotary member that is connected to an output shaft OUTPUT and operated as an output element, a second rotary member that is supplied with power from the engine 1 and operated as an input element, and a third rotary member that is connected to the first motor generator MG1 and operated as a fixing element selectively fixed by a friction member B.

In the planetary gear set PG, for example, the first rotary member may be a sun gear S, the second rotary member may be a carrier CR, and the third rotary member may be a ring gear R.

That is, the sun gear S is connected to the output OUTPUT, the carrier CR is connected to the engine 1, and the ring gear R is connected to the motor generator MG1 at a first end and to the friction member B at a second end.

An engine input gear 5 is fitted on the input shaft INPUT and engaged with the carrier CR, so the carrier CR and the engine 1 can be connected to each other. The brake member B may be a brake on the inner side of a transmission case 7.

The second motor generator MG2 supplies power to the output shaft OUTPUT. The first motor generator MG1 and the second motor generator MG2 may provide an electric load or generate electricity.

That is, according to this configuration, a vehicle can be driven in an EV mode using the second motor generator MG2, in a power split mode in which the power from the engine 1 is split to the output OUTPUT and the first motor generator MG1 through the planetary gear set PG, and in a power split OD mode in which the friction member B is selectively operated for braking.

In particular, in the EV mode, other than the components for transmitting power to the output OUTPUT and only the planetary gear set PG is operated by the power from the second motor generator MG, so a loss of power from the second motor generator MG2 is minimized, and thus, shifting efficiency is improved and fuel efficiency of a vehicle is improved accordingly.

Further, in the power split mode and the power split OD mode, the number of components (gear sets and bearings) rotated by the power from the engine 1 is minimized, so a loss of power from the engine 1 is minimized and fuel efficiency is improved accordingly.

In an exemplary embodiment of the present invention, the planetary gear set PG may be concentrically arranged on the output shaft OUTPUT.

That is, as the planetary gear set PG is concentrically arranged on the output shaft OUTPUT, it is possible to reduce the entire length of a transmission, as compared with the existing structure of a transmission with the planetary gear set PG on an input shaft, so the engine room can be more freely designed.

Further, in an exemplary embodiment of the present invention, the input shaft INPUT is directly connected to the engine 1, and a pair of external gears 3 are fitted on the input shaft INPUT and the output shaft OUTPUT, respectively, in mesh with each other.

The second motor generator MG2 may be connected to a motor input gear 3a that is one of the pair of external gears 3 on the input shaft INPUT.

The motor input gear 3a may be relatively rotated on the input shaft INPUT. A motor output gear 3b, which is a remaining one of the pair of external gears 3 on the output shaft OUTPUT, may be rotated with the output shaft OUTPUT.

That is, it is possible to increase torque transmitted to the output OUTPUT by transmitting the torque from the second motor generator MG2 to the output shaft OUTPUT through the pair of external gears 3, such that it is possible to reduce the manufacturing cost and weight of the second motor generator MG2 by decreasing the capacity of the second motor generator MG2.

Hereafter, the power flows in driving modes in an exemplary embodiment of the present invention is described.

<EV mode>

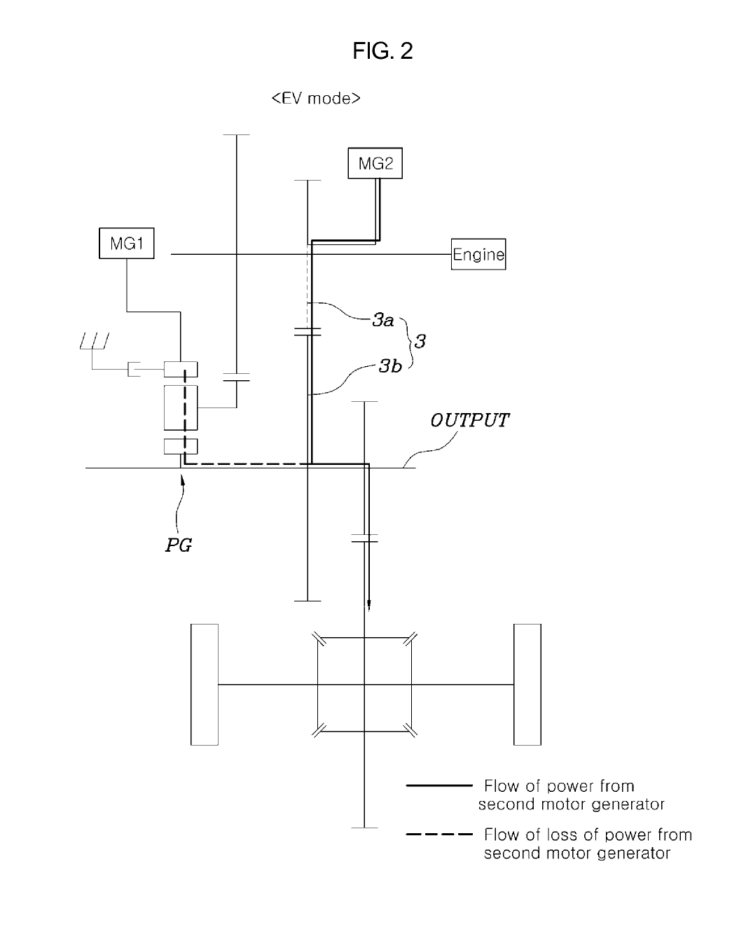

Referring to FIG. 2, torque from the second motor generator MG2 is transmitted to the output OUTPUT through the pair of external gears 3, so driving in the EV mode is possible.

In particular, the friction member B is not engaged in this mode, so only the planetary gear set PG is operated by the power from the second motor generator MG2 without the power from the first motor generator MG1 transmitted, such that a loss of electric power of the second motor generator is minimized.

<Power Split Mode>

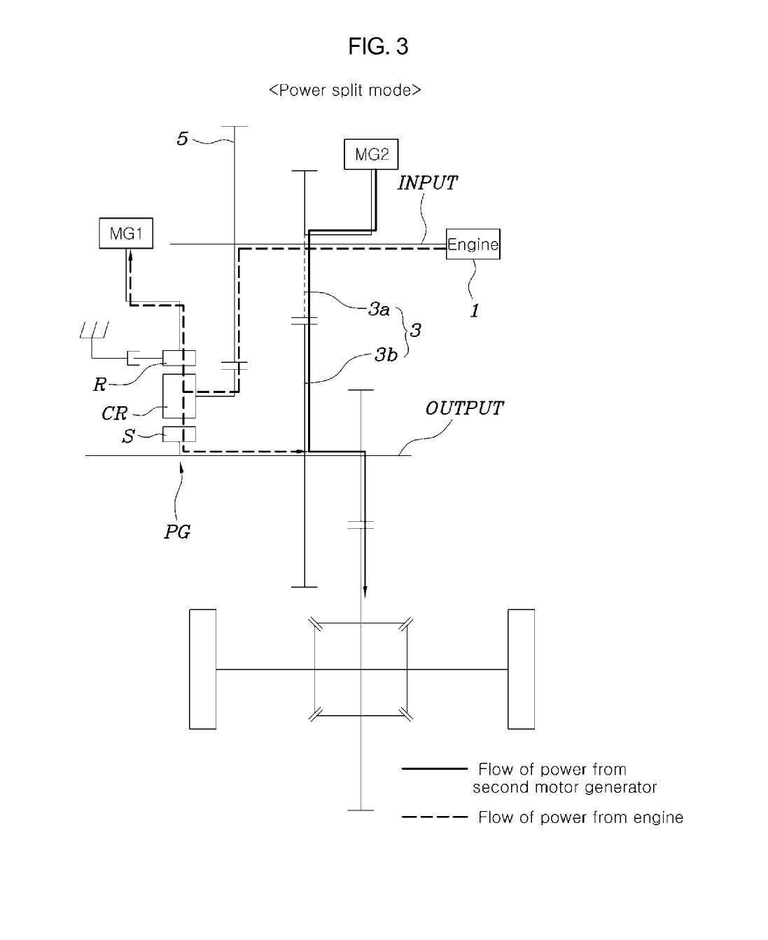

Referring to FIG. 3, when the power from the engine 1 is input to the carrier CR, the power from the engine 1 can be controlled to be split to the first motor generator MG 1 and the output shaft OUTPUT through the sun gear S and the ring gear R and used for power generation and output, and the electric power from the first motor generator MG1 and the power from the engine 1 are both provided to the output shaft OUTPUT, such that the power split mode can be achieved.

<Power Split OD Mode>

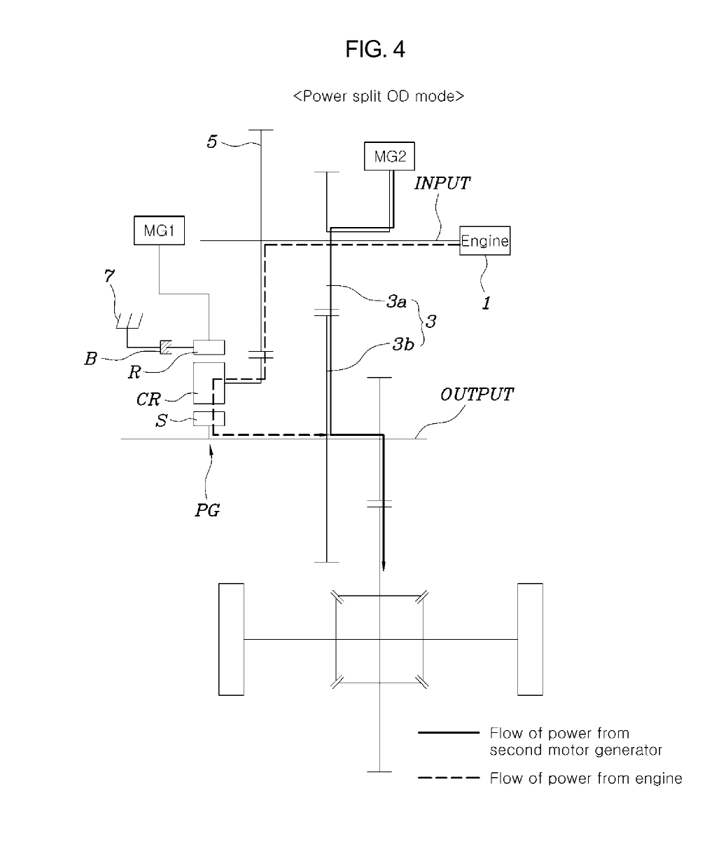

Referring to FIG. 4, when the power from the engine 1 is input to the carrier CR, with the ring gear R fixed by the friction member B, the power from the engine 1 is increased through the sun gear and output to the output shaft OUTPUT, so the power split OD mode can be achieved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A powertrain apparatus for a vehicle, comprising:
a planetary gear set including:
a first rotary member connected to an output shaft and operated as an output element;
a second rotary member supplied with power from an engine and operated as an input element; and
a third rotary member connected to a first motor generator and operated as a fixing element selectively fixed by a friction member; and
a second motor generator supplying power to the output shaft.

2. The powertrain apparatus of claim 1, wherein in the planetary gear set, the first rotary member is a sun gear, the second rotary member is a carrier, and the third rotary member is a ring gear.

3. The powertrain apparatus of claim 1, wherein the planetary gear set is concentrically arranged on the output shaft.

4. The powertrain apparatus of claim 1, wherein the fiction member is a brake inside a transmission case.

5. The powertrain apparatus of claim 1, wherein the input shaft is directly connected to the engine,
a pair of external gears are fitted on the input shaft and the output shaft, respectively, in mesh with each other, and
the second motor generator is connected to a motor input gear that is one of the pair of external gears on the input shaft.

6. The powertrain apparatus of claim 5, wherein the motor input gear is relatively rotated on the input shaft.

7. The powertrain apparatus of claim 5, wherein an engine input gear is fitted on the input shaft, and
the engine input gear is engaged with the second rotary member.
